(19) United States
(12) Patent Application Publication
(10) Pub. No.: US 2025/0005868 A1
(43) Pub. Date: Jan. 2, 2025

(54) SYSTEM AND METHOD FOR GENERATING A VIRTUAL OVERLAY IN AN XR ENVIRONMENT

(71) Applicant: Adeia Guides Inc., San Jose, CA (US)

(72) Inventors: Mona Singh, Cary, NC (US); Reda Harb, Tampa, FL (US); Kyle Beckemeyer, Park Ridge, IL (US)

(21) Appl. No.: 18/215,493

(22) Filed: Jun. 28, 2023

(51) Int. Cl. G06T 19/00; G06F 3/01; G06Q 30/0251; G06Q 30/0601; G06V 10/25

(52) U.S. Cl. CPC G06T 19/006; G06F 3/013; G06Q 30/0253; G06Q 30/0643; G06V 10/25; G06V 2201/07

(57) ABSTRACT

Systems and methods are described for monitoring and analyzing user interactions within an extended reality (XR) environment. Objects and their attributes are determined and compared to a model of attributes of interest of a user. A second object exhibiting a stronger correlation with the current attribute of interest of the user is displayed through virtual overlays in an XR environment.

### BACKGROUND

The retail industry is constantly evolving, driven by advancements in technology and shifts in consumer behavior. In recent years, the growth of e-commerce has significantly disrupted traditional brick-and-mortar retail, with consumers increasingly turning to online platforms for convenience, variety, and competitive pricing. However, despite the rise of e-commerce, physical stores continue to play a crucial role in the shopping experience, offering unique advantages such as the ability to see, touch, and try products in person, as well as the opportunity to receive personalized assistance from knowledgeable staff.

One challenge faced by traditional retailers is how to enhance the in-store shopping experience and bridge the gap between the online and offline worlds. Providing personalized and relevant product recommendations is a key factor in improving customer satisfaction and increasing sales but achieving this goal can be difficult given the vast array of products available and the diversity of individual preferences.

One approach for generating product recommendations may rely on techniques such as collaborative filtering or content-based filtering, which consider user behavior patterns, product features, or a combination thereof. However, these approaches may not fully capture the nuances of a user's preferences and can be limited by a lack of data and having to start from a point which understands little about the user, particularly for new users or products.

Moreover, some approaches do not fully leverage the potential of emerging technologies such as extended reality (XR), which combines elements of virtual reality (VR), augmented reality (AR), and mixed reality (MR) to create immersive experiences that seamlessly blend digital and physical environments. The use of XR technology in retail settings has the potential to significantly enhance the delivery of information, e.g., during a shopping experience, offering new ways for users to discover, evaluate, and interact with products.

### SUMMARY

Systems and methods are provided herein for enhancing user experience within extended reality (XR) and/or non-XR environments, e.g., by providing an improved system for delivering information to a user. In one approach, this is achieved by monitoring the user's gaze direction, discerning current attributes of interest to the user, and delivering information, e.g., a tailored product suggestion, through virtual overlays and/or alternative suitable means depending on the interest. One or more disclosed techniques may be implemented to provide (e.g., to a user) information relating to an object in the XR environment. In some examples, recommendations that are closely aligned with the user's preferences may be provided to the user. In an embodiment, the user's gaze and current attributes of interest may be analyzed to determine that a user is trying—and failing—to find a product having a particular set of attributes. In light of such a determination, information may be provided (e.g., via a virtual overlay) to address the user's current attributes of interest, e.g., by recommending another object or product that the user may find useful. The provision of such information may result in fewer interactions with a system, which may reduce an overall computational load of the system. For example, the systems and methods disclosed herein may provide dynamic, e.g., real time or near real time, feedback relating to a user's behavior or actions in an XR environment, and generate for provision to the user information relating to their behavior or actions. Such feedback of information may result in the user not needing to perform one or more operations to obtain said information by themselves, thus reducing an overall operational load on a system and improving a user's response time to their behavior and/or actions in the XR environment.

The term ‘information’ may comprise a ‘recommendation’, e.g., not necessarily confined to product recommendations. In some instances, the term extends to various forms of media assets, advertisements, and other types of content. By leveraging user gaze and interest attributes, the disclosed examples may facilitate personalized/customized delivery of a wide range of media assets including but not limited to video clips, music tracks, digital artwork, promotional ads, educational content, or news articles. For example, such personalization/customization may be resultant from modification of existing information, e.g., an existing recommendation.

In the disclosed systems and methods, an XR environment may be provided by an XR system comprising one or more XR devices, such as an XR headset, smart glasses, or other wearable devices, which may be equipped with sensors and cameras that detect the user's gaze directed towards an object. In some examples, the one or more XR devices may be used to identify an object that a user is looking at. Additionally, or alternatively, one or more devices external to the XR system, such as a smartphone, external cameras, or other gaze tracking system, may be used to identify an object or attribute that a user is looking at.

The disclosed systems and methods may analyze the properties of an object (e.g., a first object), such as product type, brand, color, size, price, and other relevant properties. The properties of the object may be compared to current attributes of interest, which may be selected from a database and/or model based on the user's past behavior, preferences, and demographic information, etc. In some examples, the current attributes of interest of a user may be different from their previous or historic attributes of interest, e.g., due to a change in situation or environment. As such, the present systems and methods account for the attributes of interest of a user changing over time, e.g., data representing their interest in something may be updated to reflect changes in interest. In some examples, the systems and methods may determine whether another object (e.g., a second object) better exhibits the current attributes of interest. In response to this determination, a virtual overlay may be displayed, e.g., providing information relating to the object, such as a recommendation for the other object that exhibits the current attributes of interest.

In some examples, the systems and methods may involve determining a product

category of the first object identified by the user's gaze. Control circuitry may proceed to identify the second object from a set of objects belonging to a product category of the first object. This allows for more accurate and/or relevant information to be provided to the user in the XR environment, thus reducing subsequent user actions in the XR environment to discover relevant information. In some examples, a targeted recommendation maybe provided to the user, as the second object selected would be within the same category as the original object of interest, ensuring relevance to the user's preferences.

In some examples, a data input may be received, which may be in the form of a user selection of the virtual overlay, e.g., resultant from one or more gestures, voice commands, or other input methods, relating to the virtual overlay. In response to the data input, the first object and/or the second object may be added to a virtual cart for purchase. Data inputs from external sources, such as transaction databases, may be received to determine if the first object and/or second object is purchased by the user. A model of attributes of interest may be updated by promoting purchased objects and/or demoting non-purchased objects, e.g., by way of a scoring system.

In some examples, the user's gaze patterns may be monitored, e.g., to identify gaze locks, referring to when the user's gaze remains focused on an area in the XR environment for longer than a pre-determined period. In some examples, images corresponding to the identified gaze lock may be captured and analyzed to identify objects and their common attributes, and update the model of attributes of interest based on the common attributes.

In some examples, ‘common attributes’ might refer to features that multiple objects share. For instance, consider various food items such as sodas, sparkling waters, and energy drinks. A common attribute among these items is that they are all fizzy drinks. This characteristic is shared across all these objects and can be employed to categorize or group them in a meaningful way, providing useful information for analyzing consumer preferences or recommending similar products.

In other examples, ‘common attributes’ might refer to attributes that frequently appear within a specific category. For instance, in the context of fizzy drinks, a common attribute could be a popular flavor like ‘cola’ or ‘lemon.’ These flavors occur frequently in the fizzy drink category.

In some examples the display of an entire aisle or part of store may be changed to display only the products that meet the attribute criteria. In some examples, the product orientation may be changed to display the attribute that the user showed interest in.

In some examples, the virtual overly may point to a product in-store, highlighting the product with a visual indicator, and/or providing directions to the product's location within the store. This may be particularly helpful in large retail environments, where finding specific items may otherwise be challenging.

The systems and methods disclosed herein may train one or more networks, e.g., using an output of one or more of the above processes, such as object identification, matching of object properties with attributes of interest, user interactions with objects (e.g., by virtue of determining a user's gaze lock), interaction with virtual overlays, and/or generating information, e.g., a product recommendation for a user. In this manner a model of attributes of interest may be developed to improve the accuracy of information retrieval, e.g., information relating to an object that the user is looking at and/or recommendations for other objects that a user may be (more) interested in. These networks may utilize machine learning algorithms to adapt and refine the information generation process over time. As more users interact with the system and provide feedback, the networks may identify patterns and trends that lead to more accurate information retrieval and better product recommendations for individual users and user groups.

In some examples, one or more product recommendations may be determined by selecting a product from multiple suitable products based on the user's historical data. This historical data may include purchase history, browsing history, and/or other behavioral data that indicate the user's preferences. In some cases, the system may incorporate data from other users with similar preferences to generate more accurate recommendations.

In some examples, one or more options may be presented to the user to purchase on object from multiple different online stores, offering a seamless integration of in-store and online shopping experiences. The user may compare prices, read reviews, and access additional product information directly within the virtual overlay, without needing to use a separate device, which can simply system operation. This feature may lead to more informed purchasing decisions and a more convenient shopping experience.

In some examples, a user may be provided with personalized advertisements, promotions, discounts, or rewards based on their shopping history and preferences. This may further enhance the shopping experience by offering users incentives that are tailored to their interests, increasing the likelihood of a purchase.

To enhance the overall shopping experience, the systems and methods provide a more immersive and personalized approach for users, enabling them to easily identify products that match their preferences and requirements while minimizing the time spent browsing (e.g., a lower operational requirement from a system standpoint) and searching in-store (e.g., physical or virtual) and/or online. Additionally, the improved product recommendations may lead to increased customer satisfaction and potentially higher sales for retailers.

The systems and methods disclosed herein may be used in other contexts beyond retail environments. For example, browsing media content such as movies, television shows, music, and books in an XR environment could be enhanced through the provision of more accurate information and/or personalized recommendations based on the user's interests, preferences, and viewing or listening history. In another example, the systems and methods may be applied to public spaces such as museums, galleries, or exhibition halls, where users may receive information or personalized information for exhibits or artworks based on their interests and preferences. The systems and methods may be used in educational settings, where students may receive accurate learning materials and information based on their learning styles, interests, and performance.

The systems and methods disclosed herein may be used in non-XR environments, such as physical stores or e-commerce websites. In some examples, information, such as the recommendations described herein, may be provided to a user as an audio message through headphones in a store or, for example, as a displayed link on an e-commerce site (e.g., instead of or along with a virtual overlay).

According to the systems and methods described herein a gaze of a user directed to an object is identified, e.g., in an XR environment. Properties of the object, a current attribute of interest of the user, and a correlation between the one or more properties of the first object and the current attribute of interest of the user are determined. In response to the determining the correlation, a second object having one or more properties exhibiting a stronger correlation with the current attribute of interest of the user is identified using control circuitry. In response to identifying the second object a virtual overlay in the XR environment comprising an information relating to the second object is displayed using control circuitry.

In some examples the virtual overlay is interactive, and the method comprises receiving a user selection of the virtual overlay. In response to receiving the user selection, the second object is added in a virtual cart for purchase.

In some examples, a data input is received from a transaction database which is used to determine whether the second object has been purchased by the user.

In some examples, a database containing a model of attributes of interest of the user is updated by increasing a relevance score of the attributes corresponding to a purchased object; and/or decreasing a relevance score of the attributes corresponding to a non-purchased object.

In some examples, the systems and methods further comprise identifying when the user's gaze remains focused on an area in the XR environment for longer than a predetermined period, capturing an image of the area of focus, analyzing the image to identify an object in the image, identifying one or more properties of the object, and updating, based on the properties of the object, a model of attributes of interest of the user.

In some examples, the virtual overlay comprises visually highlighting the second object in the XR environment; and/or navigational instructions to the second object in the XR environment.

In some examples, the virtual overlay comprises a modified advertisement for the second object.

In some examples, the method comprises training a model of attributes of interests for the user using user interactions with the first object, the second object and/or one or more virtual overlays.

In some examples, the method comprises determining a user reaction relating to the first object, the second objects and the virtual overlay, training the model based on the user reaction, and updating the model of attributes of interest using the trained data.

### BRIEF DESCRIPTION OF THE DRAWINGS

The above and other objects and advantages of the disclosure will be apparent upon

consideration of the following detailed description, taken in conjunction with the accompanying drawings, in which like reference characters refer to like parts throughout, and in which:

FIG. 1 illustrates an overview of the system for displaying a virtual overlay providing a product recommendations within an XR environment, in accordance with some examples of the disclosure;

FIG. 2 shows a block diagram showing components of an example system for generating one or more display elements in an XR environment, in accordance with some examples of the disclosure;

FIG. 3 is a flowchart representing a process for displaying a virtual overlay providing information to a user, in accordance with some examples of the disclosure;

FIG. 4 illustrates a system for determining one or more properties of an identified object, in accordance with some examples of the disclosure;

FIG. 5 Illustrates an interactive virtual overlay, which allows users to select recommended objects for addition to a virtual cart, in accordance with some examples of the disclosure;

FIG. 6 shows a system for updating a model of attributes of interest based on purchased and non-purchased objects, in accordance with some examples of the disclosure;

FIG. 7 illustrates an example for updating a model of attributes of interest based on identified gaze locks of a user, in accordance with some examples of the disclosure;

FIG. 8 illustrates an example of a virtual overlay, in accordance with some examples of the disclosure;

FIG. 9 illustrates an example of a scenario where the virtual overlay comprises a modified advertisement for the second object, in accordance with some examples of the disclosure;

FIG. 10 illustrates and example of a scoring system within the model of attributes of interest, in accordance with some examples of the disclosure;

FIG. 11 depicts a flowchart detailing the process of updating a user interest model based on purchased and non-purchased objects, in accordance with some examples of the disclosure.

### DETAILED DESCRIPTION

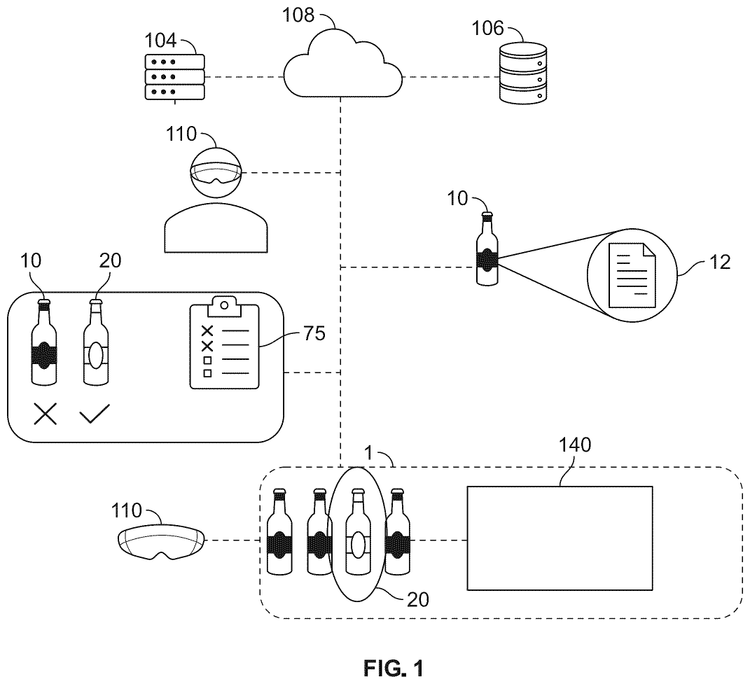

FIG. 1 illustrates an overview of a system for displaying a virtual overlay 140, in an XR environment 1, comprising a recommendation for the second object 20. The system is configured to identify, using control circuitry, a first object 10, to which the gaze of a user is directed in an XR environment 1; determining, using control circuitry, one or more properties 12, of the first object 10; determining, using control circuitry, a current attribute of interest 75, of the user; determining, using control circuitry, a correlation between the one or more properties 12, of the first object 10 and the current attribute of interest 75, of the user; in response to the determining the correlation, identifying, using control circuitry, a second object 20, having one or more properties 12, exhibiting a stronger correlation with the current attribute of interest 75, of the user and in response to identifying the second object 20, displaying, using control circuitry, a virtual overlay 140, in the XR environment 1, comprising information relating to, e.g., a recommendation for, the second object 20.

In this example, the user is equipped with an XR device 110, which may be a head-mounted display (HMD), smart glasses, or any other suitable device capable of creating an XR environment. The XR environment 1, may be a virtual reality (VR), augmented reality (AR), or mixed reality (MR) environment, depending on the specific implementation.

The XR device 110, may comprise a variety of hardware components, such as cameras, sensors, processors, and displays, as well as software components, such as operating systems, applications, and algorithms, which enable it to detect and analyze the user's gaze patterns, interpret the user's interactions within the XR environment 1, and generate the virtual overlays described in the present disclosure. For example, the XR device 110, may be equipped with eye-tracking sensors and algorithms that accurately determine the user's gaze direction and duration.

In some examples, the system may utilize the inertial measurement unit (IMU), or external cameras installed in the XR device to track the user's head pose, effectively using it as a substitute for the user's gaze. Head pose, or the orientation and position of the user's head, may be used as a way to determine where the user might be looking.

In some examples, the system may track a user's eyes separately from their head pose, utilizing techniques like pupil tracking. This may provide a more precise understanding of the user's gaze or line of sight. For instance, a user might direct their attention towards an object by glancing sideways or downward, resulting in an actual gaze that is meaningfully different than the user's head pose might suggest.

In some examples, the XR device 110, is communicatively coupled to a server 104, and a database 106, via a network 108. The server 104, is responsible for managing the XR environment 1, and facilitating access to numerous services and functionalities, such as product recommendations based on the user's gaze patterns. The database 106, contains information about different products and their attributes, which is used by the system to analyze objects and determine suitable product recommendations.

When the user is within or interacting with the XR environment, they may be able to engage with various objects and elements, either virtual or real, depending on the nature of the environment. In some examples, the XR device 110, may detect the user's gaze and track its direction, focusing on a particular object within the environment. The system then analyses the properties 12, of this object, and compares them with a model of attributes of interest 70, to derive the current one or more attributes of interest 75.

In some examples, the system may use different techniques and technologies to detect and analyze the user's gaze, such as eye-tracking sensors, infrared cameras, or machine learning algorithms. For instance, there may be instances where several objects could be potential targets of a user's gaze. In such scenarios, the user's known likes or dislikes for certain attributes, such as specific products, product categories, brands, or product form factors, can be utilized to resolve ambiguity when the gaze target is not distinct. This may allow the system to determine the actual object of the user's interest more accurately. Additionally, the model of attributes of interest 70, may be based on various factors, such as user preferences, historical data, or demographic information.

In some examples, various applicable object localization, detection, or image classification techniques could be employed to identify the object of the user's gaze. This may involve the system examining images or video footage captured by an XR device, which represent the scene as observed by the user through an optical-see-through (OST) or visual-see-through (VST) display. The system may harness appropriate machine learning or deep learning strategies to localize or detect the said object.

After estimating the current attributes of interest 75, the system determines the product type associated with the object 10 and evaluates whether a distinct product better exhibits the current one or more attributes of interest. In some examples, the product type may be determined based on the object's category, function, or appearance. Furthermore, the determination of whether another product better exhibits the current attributes of interest may be based on a comparison of the object's properties and the properties of other products in the database 106.

The database 106, may be organized in a manner that facilitates efficient retrieval and analysis of product information. For example, the database 106, may be structured as a relational database, a graph database, or another suitable data storage format that allows for the efficient querying and updating of product information. The database 106, may include a variety of data sources, such as product catalogues, user reviews, expert recommendations, and other relevant information that can be used to inform the product recommendations provided by the system.

In response to the determination, the system displays a virtual overlay 140, within the XR environment, providing a recommendation for another object 20, of the same product type, that better exhibits the current one or more attributes of interest 75. This virtual overlay 140, may be displayed using various visual representations, such as textual descriptions, images, or 3D models, and may be interacted with by the user through different input methods, such as gestures, voice commands, or controller inputs.

In some examples, the virtual overlay may range from being transparent, semi-transparent, or completely opaque. It may be projected in conjunction with a secondary virtual element that emphasizes or directs attention to the focused object. The overlay may be rendered to seem as if it occupies the same three-dimensional space as the object, mimicking, for instance, signage on a store shelf. It may be rendered like a heads-up display (HUD) on the lens of an XR device, giving the illusion of being on the lens plane rather than within the 3D environment. The recommendation could incorporate any relevant audio-visual data. For instance, it might include text or images of the suggested product.

In some examples, the virtual overlay 140, may include additional features, such as highlighting the recommended product using distinct visual indicators, like color borders, glowing effects, or animated elements, and/or providing directions to the recommended product within the environment. These additional features may further enhance the user's experience and facilitate the discovery of relevant products based on their current attributes of interest, as well as reducing the overall amount of information (e.g., data) exchanged in the XR environment, since a user may locate a desire object (e.g., product) in the XR environment within a shorter period driven by increased system efficiency.

In some examples, the system may comprise additional features in the virtual overlay that brings attention to the shortcomings of the current object of interest. This might involve reminding the user about their general disliking of a specific color when buying shoes, such as white, or spotlighting important information on a nutritional label, among other things.

In some examples, the object under consideration (e.g., a product) could either be a physical commodity or an intangible service. For instance, if the user is evaluating cars for purchase, the system could potentially recommend alternatives like a car rental service or a ride-sharing application, catering to the user's immediate or future transportation needs.

In some examples, the system may be particularly well-suited for use in a supermarket or other retail environment, where the user is physically present and interacting with a variety of products in real-time. In this context, the system may leverage the user's gaze patterns and other contextual information to recommend alternative products that better exhibit the current attributes of interest, helping the user make more informed purchasing decisions.

In another examples, the system may be used in a virtual environment where the user is browsing for media content, such as movies, music, or video games, through a display or other user interface. In this scenario, the system may analyze the user's gaze patterns as they interact with the virtual environment, identifying the user's preferences and interests, and recommending relevant media content based on these insights. This could help the user discover new content that aligns with their preferences, as well as facilitate more personalized and engaging browsing experiences.

The system may also offer a variety of customization options and personalization features to users within the XR environment 1. For example, users may be able to adjust the appearance or behavior of the virtual overlay 140, such as changing the color, size, or transparency of the overlay, or modifying the way in which product recommendations are presented. Users may also have the option to set preferences for product recommendations, such as specifying preferred brands, price ranges, or other attributes that influence the types of products recommended by the system. This level of customization and personalization can help ensure that the system is tailored to the unique needs and preferences of each user, making it more useful and engaging.

In some examples, the system may also support collaborative shopping experiences, wherein multiple users can share their gaze data, product recommendations, and other relevant information within the same XR environment. This could be particularly useful for situations where users are shopping together, such as when a group of friends or family members is planning a meal or event. By aggregating and analyzing the gaze patterns and preferences of multiple users, the system is able to generate more comprehensive and relevant product recommendations that cater to the needs and preferences of the entire group.

The system may integrate with various external systems and data sources to enhance the quality and relevance of the product recommendations provided. For example, the system may access information from social media platforms, online review sites, or other sources of user-generated content to obtain insights about user preferences and product trends. This information can be used to supplement the gaze data and other inputs collected by the XR device 110, allowing the system to generate more accurate and personalized product recommendations.

The system may also incorporate various feedback mechanisms to help improve the quality of the product recommendations provided over time. For example, users may be able to rate or review the product recommendations they receive, providing valuable feedback that can be used to refine the system's algorithms and data models. Additionally, the system may track user behavior within the XR environment 1, such as whether a user purchases a recommended product and use this information to evaluate the effectiveness of the product recommendations and make any necessary adjustments to the recommendation algorithms and the model of attributes of interest 70.

In some examples, the system may also support the use of context-aware recommendations, wherein the product recommendations provided to the user are influenced by factors such as the user's location, the time of day, or other contextual information. For example, the system may prioritize the recommendation of seasonal products, time-sensitive promotions, or other contextually relevant items based on the user's current situation. This can help ensure that the product recommendations provided by the system are not only personalized to the user's interests but also aligned with their immediate needs and circumstances, e.g., based on one or more system settings.

The system may also provide users with various tools and resources to help them make more informed purchasing decisions. For example, the virtual overlay 140, may include interactive elements that allow users to access product reviews, compare prices, view nutritional information, or explore other relevant product details directly within the XR environment 1. This can help users make more educated choices about the products they purchase and enhance their overall shopping experience.

In some examples, the system may consider user-specific dietary constraints, such as food allergies or intolerances. For instance, if a user is identified as being lactose intolerant or allergic to peanuts, this information is factored into the model of attributes of interest. When the user's gaze falls upon an item containing lactose or peanuts, like milk or a jar of peanut butter, the system, aware of the user's dietary restrictions, could boost the correlation of non-dairy or peanut-free alternatives with the user's attributes of interest. Thus, the system may recommend lactose-free milk substitutes or peanut-free spreads via a virtual overlay.

In some examples, the user may interact with a virtual assistant which is configured but not limited to responding to queries, offering information, or assisting in tasks based on user input. These interactions could further inform the system about user preferences, habits, or current needs which may be incorporated into the model of attributes of interest.

In some examples, the system may be implemented in a variety of different environments and use cases, both within and beyond the retail and media content shopping examples described earlier. For instance, the system may be employed in educational settings, where users can access personalized learning materials and resources based on their gaze patterns and interests. The system may also be applied in workplace settings, helping users navigate complex tasks or workflows more efficiently by recommending relevant tools, resources, or support materials based on their current activities and needs.

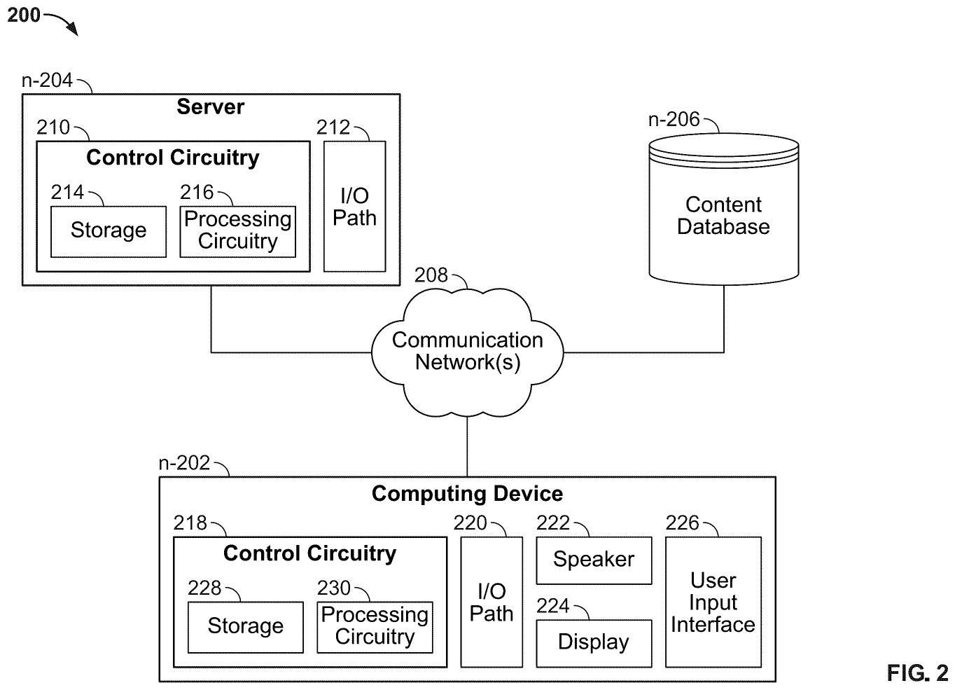

FIG. 2 is an illustrative block diagram showing example system 200, e.g., a non-transitory computer-readable medium, configured to generate display of one or more display elements, such as virtual overlays with personalized product recommendations, in an XR environment 1, related to the disclosed examples. Although FIG. 2 shows system 200 as including a number and configuration of individual components, in some examples, any number of the components of system 200 may be combined and/or integrated as one device, e.g., as an XR device 110. System 200 includes computing device n-202 (denoting any appropriate number of computing devices, such as XR headsets, smart glasses, or other wearable devices), server n-204 (denoting any appropriate number of servers), and one or more content databases n-206 (denoting any appropriate number of content databases), each of which is communicatively coupled to communication network 208, which may be the Internet or any other suitable network or group of networks.

In some examples, system 200 excludes server n-204, and functionality that would otherwise be implemented by server n-204 is instead implemented by other components of system 200, such as computing device n-202. For example, computing device n-202 may implement some or all of the functionality of server n-204, allowing computing device n-202 to communicate directly with content database n-206. In still other examples, server n-204 works in conjunction with computing device n-202 to implement certain functionality described herein in a distributed or cooperative manner.

Server n-204 includes control circuitry 210 and input/output (hereinafter “I/O”) path 212, and control circuitry 210 includes storage 214 and processing circuitry 216. Computing device n-202, which may be an XR headset, smart glasses, or other wearable devices, includes control circuitry 218, I/O path 220, speaker 222, display 224, and user input interface 226. Control circuitry 218 includes storage 228 and processing circuitry 230. Control circuitry 210 and/or 218 may be based on any suitable processing circuitry such as processing circuitry 216 and/or 230.

As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some examples, processing circuitry may be distributed across multiple separate processors, for example, multiple of the same type of processors (e.g., two Intel Core i9 processors) or multiple different processors (e.g., an Intel Core i7 processor and an Intel Core i9 processor).

Each of storage 214, 228, and/or storages of other components of system 200 may be an electronic storage device. Storage devices may store various types of content, metadata, and or other types of data for use in personalized product recommendation generation in the XR environment. In some implementations, control circuitry 210 and/or 218 executes instructions for an application stored in memory (e.g., storage 214 and/or 228). Specifically, control circuitry 210 and/or 218 may be instructed by the application to perform the functions discussed herein related to gaze analysis, attribute determination, and personalized product recommendations.

As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 2D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each of storage 214, 228, and/or storages of other components of system 200 may be used to store various types of content, metadata, and or other types of data. Non-volatile memory may also be used (e.g., to launch a boot-up routine and other instructions). Cloud-based storage may be used to supplement storages 214, 228 or instead of storages 214, 228.

In some examples, control circuitry 210 and/or 218 executes instructions for an application stored in memory (e.g., storage 214 and/or 228). Specifically, control circuitry 210 and/or 218 may be instructed by the application to perform the functions discussed herein. In some implementations, any action performed by control circuitry 210 and/or 218 may be based on instructions received from the application. For example, the application may be implemented as software or a set of executable instructions that may be stored in storage 214 and/or 228 and executed by control circuitry 210 and/or 218. In some examples, the application may be a client/server application where only a client application resides on computing device n-202, and a server application resides on server n-204.

The application may be implemented using any suitable architecture, including stand-alone applications wholly implemented on computing device n-202 or client/server-based applications where only a client application resides on computing device n-202, and a server application resides on server n-204.

In client/server-based examples, control circuitry 218 may include communication circuitry suitable for communicating with an application server (e.g., server n-204) or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may involve the Internet or any other suitable communication networks or paths (e.g., communication network 208).

In another example of a client/server-based application, control circuitry 218 runs a web browser that interprets web pages provided by a remote server (e.g., server n-204). For example, the remote server may store the instructions for the application in a storage device. The remote server may process the stored instructions using circuitry (e.g., control circuitry 210) and/or generate displays. Computing device n-202 may receive the displays generated by the remote server and may display the content of the displays locally via display 224. This way, the processing of the instructions is performed remotely (e.g., by server n-204) while the resulting displays, such as the display windows described elsewhere herein, are provided locally on computing device n-202. Computing device n-202 may receive inputs from the user via input interface 226 and transmit those inputs to the remote server for processing and generating the corresponding displays.

Computing device n-202 may send instructions, e.g., to initiate an XR experience and allow a user to view and interact with virtual overlays in the XR environment, to control circuitry 210 and/or 218 using user input interface 226.

User input interface 226 may be any suitable user interface, such as a remote control, trackball, keypad, keyboard, touchscreen, touchpad, stylus input, joystick, voice recognition interface, or other user input interfaces. User input interface 226 may be integrated with or combined with display 224, which may be a monitor, a television, a liquid crystal display (LCD), or any other equipment suitable for displaying visual images in the XR environment.

Server n-204 and computing device n-202 may transmit and receive content and data via I/O path 212 and 220, respectively. Control circuitry 210 and/or 218 may be used to send and receive commands, requests, and other suitable data related to the disclosed examples using I/O paths 212 and/or 220.

For instance, I/O path 212, and/or I/O path 220 may include a communication port(s) configured to transmit and/or receive (for instance to and/or from content database n-206), via communication network 208, content item identifiers, content metadata, natural language queries, and/or other data. Control circuitry 210 and/or 218 may be used to send and receive commands, requests, and other suitable data using I/O paths 212 and/or 220.

In operation, the system 200 allows users to experience a personalized XR environment 1, with virtual overlays containing product recommendations based on their gaze and preferences. The system may use data from content databases n-206, server n-204, and computing device n-202 to analyze user gaze patterns, determine product attributes, and generate personalized product recommendations.

As the user interacts with the XR environment, computing device n-202 captures the user's gaze data and may send it to server n-204 for processing. The server n-204 may analyze the gaze data and extracts relevant information to identify the user's interests and preferences. This information may be used to determine product attributes that align with the user's preferences.

The system 200 can also take into account user feedback, such as explicit inputs, to refine its understanding of user preferences. User feedback can be received via user input interface 226 and processed by control circuitry 218. This feedback may include likes, dislikes, additions to wish lists, or other preferences expressed by the user during their XR experience.

Once the relevant product attributes have been determined, server n-204 queries content databases n-206 to identify products that match the user's preferences. The server then generates personalized product recommendations based on the user's preferences and the products available in the content databases.

The personalized information, e.g., product recommendations, are then sent to computing device n-202, where control circuitry 218 generates virtual overlays containing the recommendations. These virtual overlays may be displayed to the user within the XR environment 1, via display 224, allowing the user to view and interact with the recommended products.

The system 200 may update the personalized product recommendations in near- or real-time based on the user's gaze data, feedback, and other contextual factors. As the user's preferences evolve or as new products become available in the content databases n-206, the system may adjust the virtual overlays to ensure that the recommendations remain relevant and engaging for the user.

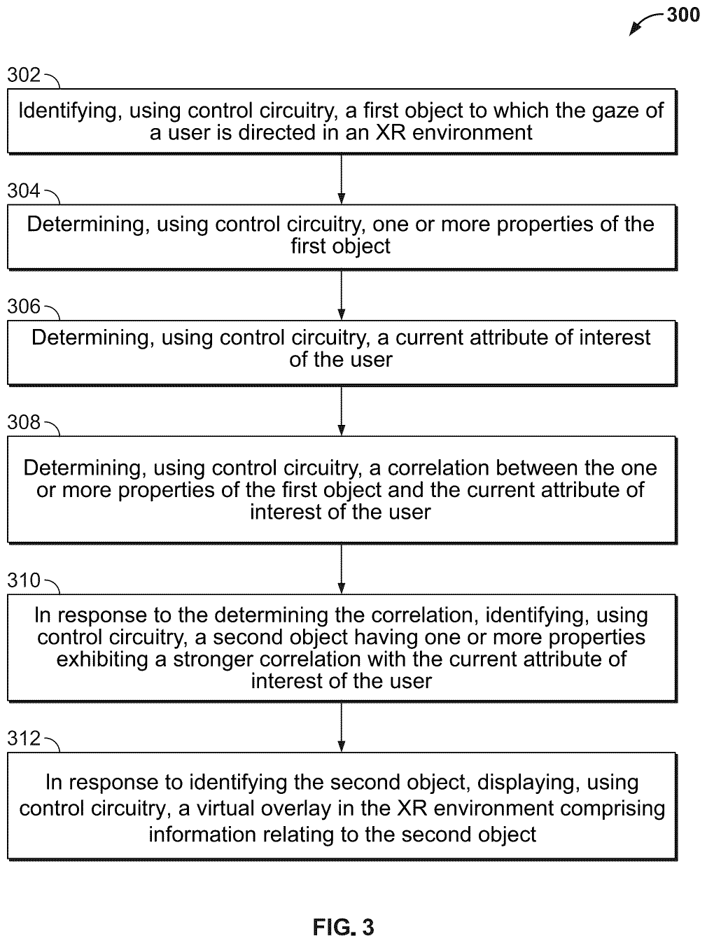

FIG. 3 presents a flowchart that illustrates the method 300 for identifying user interests

and providing information within an XR environment. For the purpose of clarity, the term “control circuitry” used in the subsequent explanation applies broadly to the control circuitry discussed earlier with reference to FIG. 2. For instance, the control circuitry may include control circuitry of the computing device 218, and control circuitry of server 210, working either in isolation or in combination with the system shown in FIG. 1.

At step 302, control circuitry, for instance, the control circuitry of XR device 110, identifies a first object 10, to which the gaze of a user is directed in an XR environment. In the context of this disclosure, the “field of view of a user” implies the extent to which a user can observe an XR environment 1, accessed using an XR device 110. This gaze tracking capability enables the system to understand what object the user is currently focusing on within the XR environment.

At step 304, control circuitry determines one or more properties 12, of the first object 10. These properties might incorporate, but are not limited to, the object's size, shape, color, or other identifiable features or textual/visual information printed on the object such as a list of ingredients. A suitable computer vision system, designed to detect and analyze objects within the user's field of view, may perform this process by extracting information apparent from the object.

The object 10, of the user's gaze could be a physical object in the real world, such as a piece of furniture in a showroom, or it could be a virtual object, such as a virtual product displayed in an online store or a media asset like a movie or a song, etc. In the case of a physical object, the system might use computer vision techniques to identify the object based on its shape, size, color, and other visual features. For virtual objects, the system can directly access the data defining those objects in the virtual environment.

Subsequently, at step 306, the control circuitry determines a current attribute of interest 75, of the user. This could involve studying the user's past interactions, preferences, or behaviors within the XR environment. It could also involve incorporating external or contextual data or utilizing machine learning algorithms to derive these attributes based on the user's behavior.

For instance, if the user is looking at a drink high in caffeine content, a current attribute of interest 75, selected from a model of attributes of interest 70, may suggest an alternative if it is late at night when the user prefers low caffeine content drinks or continue to recommend the same drink being viewed if it is early in the morning when the user prefers higher caffeine content drinks.

The system may detect and process other elements in the environment, such as store signage, to aid in determining user interest. For instance, a user spending time reading nutritional information or special offers could indicate a current attribute of interest related to health-conscious food items or low-cost alternatives.

In one example, a user's gaze is on a pair of all-white, low-top Nike basketball shoes. If the model indicates the user has a color preference for blue or grey footwear, the system may deduce that the user's interest lies in shoes (product type). The potential attributes of the object of interest could be: sub-type (basketball shoes), form factor (low-top), brand (Nike), and color (blue and green). If the same model is available in blue, the system might recommend the blue variant to the user described in a later step. In a similar example, if the user displays a brand preference for Adidas, the system might suggest a grey Adidas basketball shoe with a similar function or sub-type (basketball) and form factor (e.g., low-top).

In some examples, the system might account for the preferences of the user's household members to infer the user's current interests. For instance, if a second user is known to share the same household with the primary user, the system might deduce that the primary user is interested in purchasing something for the second user. In this context, the system might reference a model of the second user's interests to evaluate whether the current object of focus aligns with the primary user's interest. This second model could also guide the product recommendation made to the primary user.

In some instances, the system may initiate a prompt asking the primary user to confirm if they are shopping for someone else. In other instances, the primary user may voluntarily notify the system they are shopping for a second user. If desired, the primary user could explicitly indicate for whom they are shopping. This feature may allow the primary user to feel like they are choosing something for the second user beyond simply selecting from a list provided by the second user.

In some examples, the primary user might not be aware of their current preferences or interests. Complex interrelationships might suggest an interest in a set of attributes or products that would not naturally occur to the user. For example, the system might identify that the user has an unrealized preference for butternut squash under highly contextual conditions (e.g., only purchasing, or consuming butternut squash in October, when the temperature is below 65 degrees, and when it is overcast). If the user is examining various foods in the frozen food section, the system might recommend purchasing butternut squash (either in-store or online). In some cases, the system might provide a list of multiple recommended items for purchase.

At step 308, the control circuitry determines a correlation between the one or more properties 12, of the first object 10, and the current attribute of interest 75, of the user. This analysis helps the system comprehend how the observed object's properties 12, relate to the user's interests. The correlation may be determined through statistical analysis methods, machine learning algorithms, or any other suitable methods.

In one example, the model of attributes of interest may incorporate a dynamically updated record of various object properties, each being scored and ranked based on the historical preferences exhibited by the user. The object properties 12, might include, but are not limited to, aspects such as color, size, brand, material, function, price range, and design style, among others.

Each object property in this list may be assigned a score, which is an indicator of the user's preference for that particular attribute. The scoring mechanism may be rooted in the user's purchasing behavior. Specifically, if a user repeatedly purchases objects that exhibit a certain property, the score for that property in the user's model of attributes of interest 70, may increase. Conversely, properties that are rarely or never associated with purchased objects may be assigned lower scores, thus reflecting a lesser interest.

To elaborate, consider a user who frequently purchases electronic devices of a particular brand. In this case, the brand attribute for that specific manufacturer may accrue a high score in the model, reflecting the user's brand preference. Similarly, if a user often buys objects of a particular color, the color attribute in the model for that specific color may obtain a higher score, indicating the user's color preference.

Additionally, the model of attributes of interest 70, may be designed to adapt to various contextual factors. These factors might include the time of day, the day of the week, the month or season of the year, the current weather, and the user's location, among other context-specific elements. This ensures that the model stays dynamic and relevant, as user preferences can change based on different contexts.

For instance, if a user tends to purchase warm clothing during winter months, the model could factor in the current season to elevate the scores of properties associated with warm clothing during this period. Similarly, if a user usually buys a specific brand of sunscreen during sunny weather conditions, the model could recognize this pattern and elevate the score for this brand whenever the weather forecast predicts sun. By continually learning from the user's behavior and adapting to various contextual factors, this model allows for a personalized and context-aware user experience in the XR environment.

In another instance, the system may verify the user's presence in a physical store by comparing the images captured from the user's perspective (e.g., though an XR device) with known or previously collected images of the store. Additional cues, such as detected Wi-Fi networks or position data (e.g., GPS coordinates), may provide evidence of the user's location.

Once the correlation is established, at step 310, the control circuitry identifies a second object 20, that possesses one or more properties 12, exhibiting a stronger correlation with the current attribute of interest 75, of the user. This involves comparing the properties of various objects within the XR environment 1, and selecting the one that best aligns with the user's identified interest. This can involve complex computation and may also incorporate predictive modelling to forecast the user's future interests based on their current and past behavior.

At step 312, in response to identifying the second object 20, the control circuitry displays a virtual overlay 140, in the XR environment 1, containing a recommendation for the second object 20. The virtual overlay 140, can be positioned relative to the user's field of view and can provide additional information or options related to the second object 20. This overlay can be interactive, allowing the user to engage with the recommended object 20, or it can be a static informational display, providing additional context or insight about the second object 20, to the user.

To eliminate any doubt, the sequence of operations in the process 300 can be carried out in a different order or in parallel to further the objectives of this disclosure.

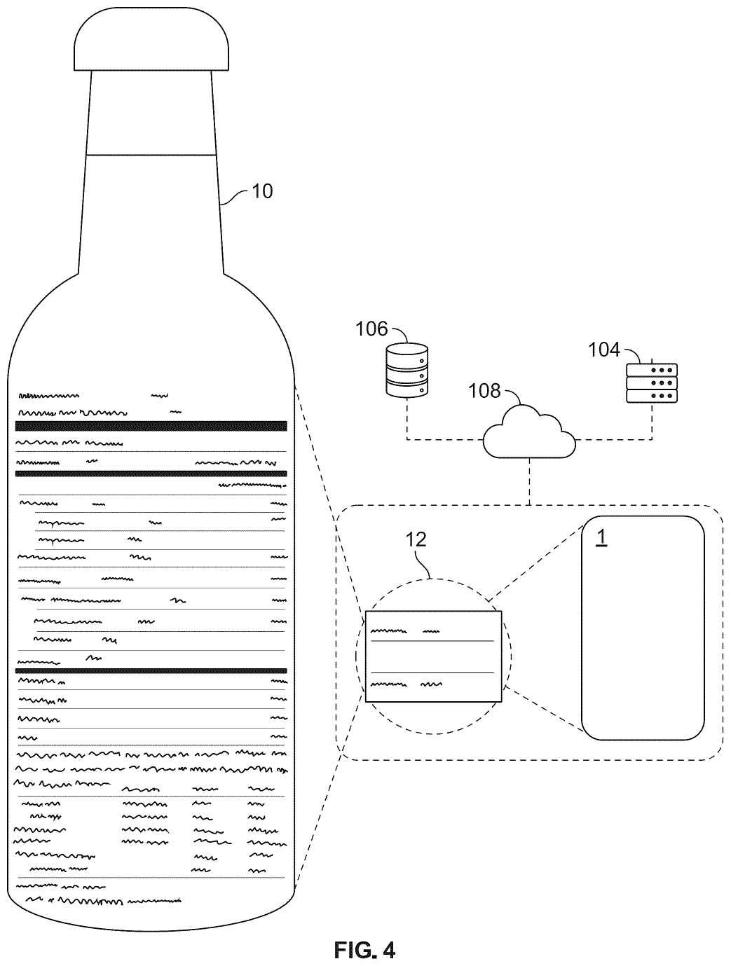

FIG. 4 demonstrates an object 10, being viewed within an XR environment. This object, which can be a physical or virtual entity, is identified by the control circuitry implemented within the XR system. The object 10, in one example, may represent a food item or a product package containing food. As part of the identification process, the control circuitry is configured to determine the properties 12, of the object. These properties could range from physical attributes, such as color, size, and shape, to more abstract attributes like brand name, price, and in the case of food items, nutritional information printed on the item.

In one example, the object 10, as seen in the XR environment 1, presents a list of ingredients and nutritional information. This data might be displayed directly on the object itself, on a virtual overlay 140, associated with the object, or may be retrieved from a database 106, that is connected to the XR system. For instance, when the object is a packaged food product, the control circuitry may utilize optical character recognition (OCR) technology, machine learning algorithms, or a combination thereof to extract the list of ingredients and nutritional information from the product's packaging.

In some examples, the control circuitry may use image recognition or object recognition algorithms to identify the object 10, and its properties 12. For instance, if the object is a piece of clothing, the system could analyze the color, pattern, and category of the clothing item to determine its properties 12. Similarly, if the object is a book, the system could recognize the cover design, the author's name, or even specific symbols or images on the cover that could provide additional context or information about the book. In some instances, object recognition techniques may be implemented to identify objects and object properties for items that are: (i) purchased; (ii) placed in a shopping cart; and/or (iii) considered but not purchased (e.g., this determination may be made based on detecting a sufficiently long gaze at an object that is not purchased or not placed in a cart).

In some examples, the control circuitry may also use AR or QR codes or any other type of identifier associated with the object to quickly and accurately identify the object and fetch relevant information from a database. This code may comprise (or provide a link to) important information about the object under focus. For instance, the QR code might disclose a stock keeping unit (SKU), a product name, a product category, or any other attributes of the product. The QR code may be positioned on the object of interest or in its close vicinity. This information could then be displayed in the XR environment 1, as a virtual overlay 140, providing the user with detailed insights about the object.

It is also possible for the XR system to interface with external databases or online sources to fetch additional information about the object. For instance, if the object 10, is a product available for sale online, the XR system could retrieve product reviews, ratings, and other relevant information from e-commerce websites or social media platforms, providing the user with a more comprehensive view of the object.

Once the information is extracted, it is then compared with a current attribute of interest 75, of the user. This attribute of interest may be predefined by the user, inferred from past user behavior, or predicted by a machine learning model based on a variety of factors, including but not limited to the user's past interactions, time of day, location, or biometric data. For example, if the user's current interest is to consume lower amounts of sugar, the control circuitry may compare the sugar content of the object 10, (as derived from the nutritional information) with the user's current attribute of interest 75. The current attribute of interest, as mentioned earlier, may be derived from a model of attributes of interest 70, that is developed and maintained by the control circuitry.

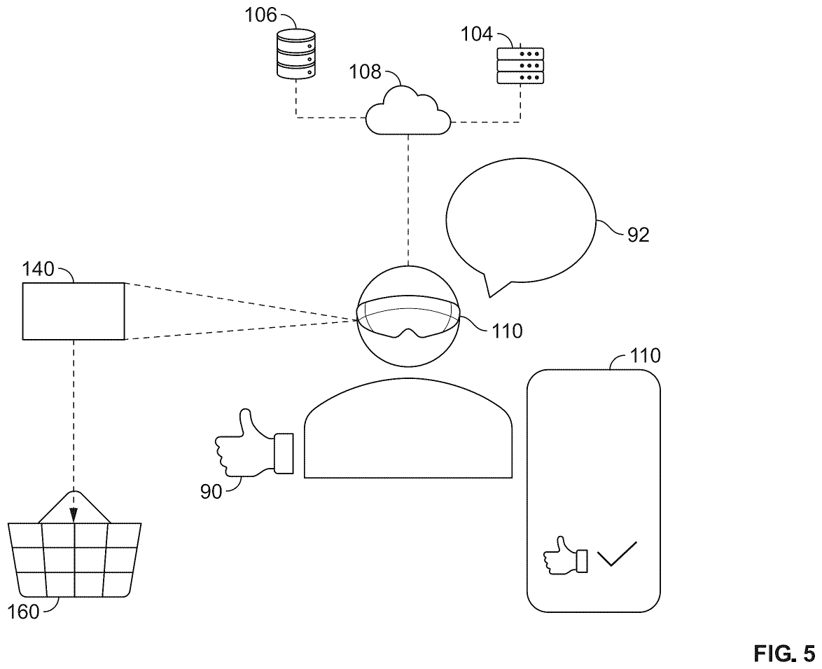

FIG. 5 illustrates an exemplary scenario involving a user interacting with multiple XR devices in an immersive XR environment. The user is presented with a virtual overlay 140, containing a product recommendation. This virtual overlay 140, could be displayed via any of the XR devices, such as an XR headset, smart glasses, mobile device, or other wearables. The overlay may contain detailed information about the recommended product, including but not limited to the product's name, description, price, and images or 3D models.

In this example, the user expresses interest in the recommended product through a gesture 90, in this case, a thumbs-up gesture. This gesture, captured and identified by one or more sensors on the XR devices, serves as an affirmation of the user's intent to purchase the recommended product. The gesture recognition system of the XR devices may be trained to recognize a variety of hand gestures or other bodily movements, allowing for intuitive and natural user interaction within the XR environment.

In addition to or alternatively from the thumbs-up gesture, the user confirms their interest in purchasing the product through a voice command 92. This voice command is captured by the microphone of the XR device 110, and processed by a voice recognition system integrated into the control circuitry. The voice recognition system converts the spoken words into text or actionable commands, confirming the user's intention to purchase the recommended product.

The system may be configured to identify a wide spectrum of user gestures, both multi-gesture and multi-modal inputs. For examples, a ‘swipe left’ or ‘swipe right’ gesture could indicate rejection or approval of a product as an example of a multi-gesture input. Similarly, a ‘pinch’ gesture could symbolize an intention to gather more information about a product, alongside a verbal interaction wherein the user utters “cancel” to cancel the previous interaction.

Upon receipt of the user's confirmation via, for example, gesture 90 or voice command 92, the control circuitry adds the selected product to a virtual shopping cart or basket 160. This basket may be symbolically represented in the XR environment 1, and is accessible to the user. This cart may be represented in the XR environment 1, in a variety of ways. For example, it could be visualized as a floating icon or a specific area in the user's field of view that can be accessed and reviewed at any time. The virtual shopping cart is a dynamic representation of the user's intended purchases, and items can be added or removed based on the user's interactions. In some examples, the user may offer direct input indicating their intent to add an object to a shopping cart for purchase, for example, through a specific gesture or voice command. The user may use an XR device, such as a headset to scan barcodes or other identifiers of items they are placing in their shopping cart. In this way, once the user finishes shopping, they can pay via the headset and exit the store. The XR device may relay information to the store's network to acknowledge the user's status as a customer who has already paid.

Once the user has finished their shopping and is ready to make a purchase, they may choose to do so either online or in-store. If the user opts for online purchasing, they can proceed to a virtual checkout, where payment information can be securely entered, and the transaction can be completed without ever leaving the XR environment 1. The purchased goods can then be shipped to the user's specified location.

If the user prefers to make the purchase in-store, the XR system may generate a unique code or QR code associated with the user's virtual shopping cart. This code can be scanned at a physical checkout point in the store, allowing the items in the virtual shopping cart to be seamlessly transferred to the physical point of sale system. The user can then pay for the items in the usual manner, whether it be cash, card, or mobile payment.

In some examples the user may proceed to a point-of-sale (POS) system within the store. The XR device may transmit the list of items in their cart to the POS system. The user then completes the payment using, for instance, contactless payment methods like a credit card or phone.

In some instances, the XR system may enable hybrid shopping wherein a user is simultaneously shopping for items in-person and online. For example, as a user is walking through the store, he might add a first item to his physical cart (with no recommendation for a different product from the system). Then, the user might consider a second item. The XR system may recommend a different product (e.g., via a virtual overlay), which the user may add to his virtual shopping cart. In some instances, the XR system may prompt the user, requesting feedback (e.g., gesture or audio feedback) to indicate whether he would like to purchase the recommended item as a one-time purchase or as recurring subscription. In some instances, the XR system may detect an identity of the brick-and-mortar store. The XR system might detect an online store affiliated with the brick-and-mortar store. For example, the store may enable online ordering. In such an example, the XR system might enable online purchasing via a website for the brick-and-mortar establishment. In other circumstances, the store might not have a web presence (e.g., it may be a small business). However, it might be affiliated with an on-line retailer. The system may maintain a record of this affiliation, and it may reference the record to determine which online retailers should be used or preferred when facilitating an online purchase of the recommended item. In some instances, the XR system presents the user with options to purchase from multiple different online stores, enabling the user to price shop. In any event, in the case of virtual goods, such as digital media assets, game levels, or virtual reality experiences, the purchased items can be directly downloaded or streamed to the user's XR device 110, or another connected device, such as a smartphone, tablet, or computer (e.g., while the user is shopping in a brick-and-mortar establishment). This facilitates a hybrid shopping experience, allowing users to shop for both physical and virtual goods (e.g., via a single, AR or MR interface). This kind of shopping experience merges the convenience of online shopping with the experience of in-store shopping, offering users the best of both worlds.

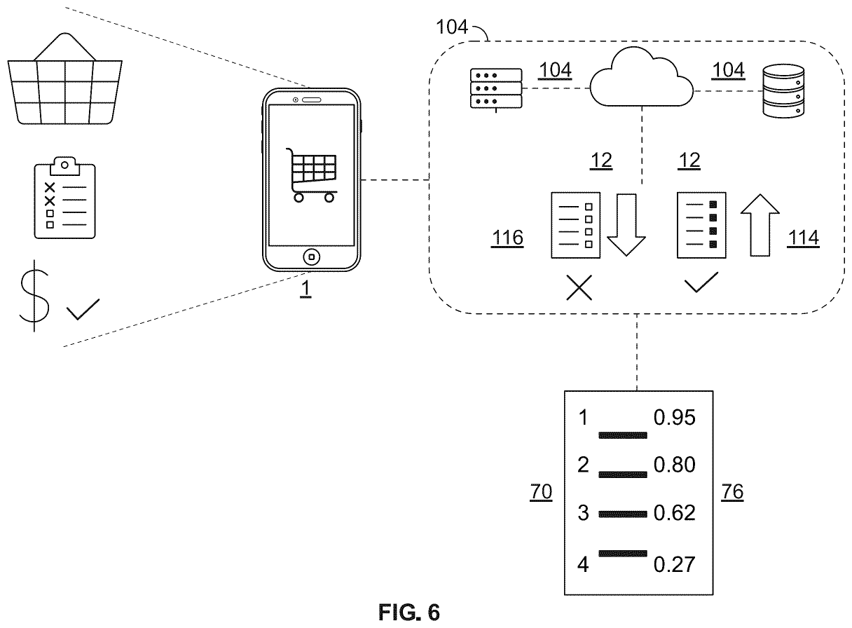

FIG. 6 illustrates a model of attributes of interest 70, which is updated following the confirmation of purchases made by the user within an XR environment 1. The model of attributes of interest 70, may incorporate a range of different product attributes 12, as mentioned earlier. Each of these attributes is assigned a relevance score 76, that represents the level of interest that the user has shown towards products possessing that attribute. The scores are determined based on the user's historical data, which may include their purchase history, browsing history, and other behavioral data.

Following a purchase, the model updates the relevance scores of the attributes associated with the purchased products. These scores may be increased, or promoted 114, to reflect the confirmed interest that the user has demonstrated by making the purchase. This promotion process may involve adding a predetermined value to the relevance score or multiplying the current score by a certain factor.

The model may also update the scores of attributes associated with products that the user chose not to purchase. These scores may be decreased, or demoted 116, to reflect the lack of interest or the preference of the user for other products. This demotion process may similarly involve subtracting a predetermined value from the relevance score or multiplying the current score by a certain factor.

By promoting the scores of purchased products and demoting the scores of non-purchased products, the model continually refines its understanding of the user's preferences and interests. This allows the system to provide increasingly accurate and personalized product recommendations over time.

Non-purchased items, aside from having their associated attributes demoted in the model, may be dealt with in various ways. In some cases, their visibility might be reduced in future sessions, or the system might attempt to re-engage the user's interest in these items by offering discounts, promotions, or by showcasing them in a different context.

This process leverages user interactions with the first object 10, the second object 20, (e.g., the recommended object), and/or one or more virtual overlays, as well as the user's reactions to these objects to cyclically train, update, and refine the model of attributes of interest 70.

Each interaction within the XR environment 1, such as a gaze lock on an object, a gesture towards a virtual overlay 140, or a voice command to add an item to the virtual cart constitutes a data point that can inform the model. Over time, these data points create a picture of the user's preferences and tendencies.

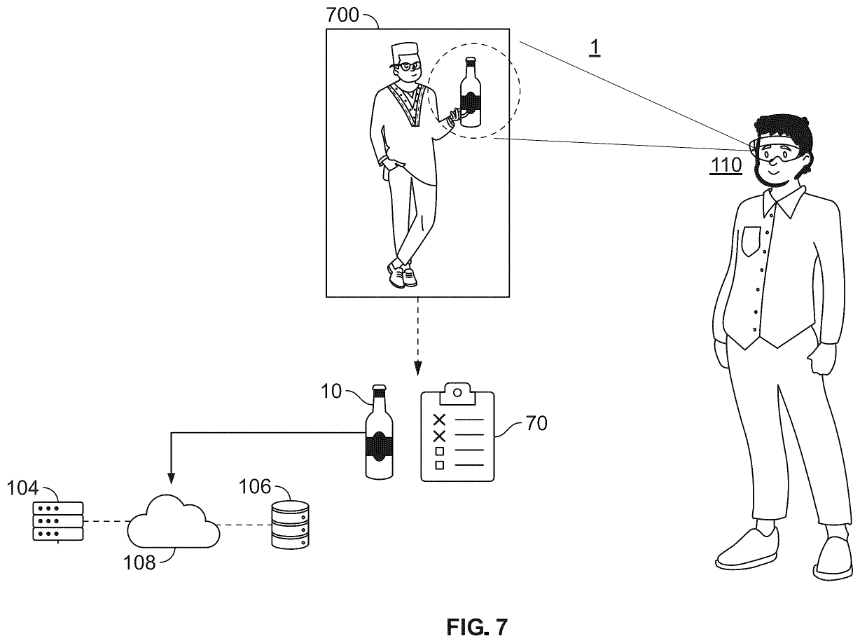

User reactions can be various and may include explicit actions such as verbal feedback, gestural feedback, or selection/non-selection of recommended items. They can also be implicit reactions inferred from the user's behavior as is explained in more detail in FIG. 7.

The model is trained based on these user reactions. Advanced machine learning algorithms, potentially including artificial intelligence (AI) techniques such as deep learning, may be employed to identify patterns and relationships in the user's behavior. This trained model is then used to update the model of attributes of interest 70. In other words, the model learns from each user reaction and adjusts its understanding of the user's interests accordingly.

With each iteration of interaction, reaction determination, model training, and model updating, the system becomes more adept at predicting the user's preferences and providing relevant product recommendations. This continual learning and adaptation make the system highly responsive and personalized to each individual user's needs and interests.

FIG. 7 depicts an instance where the user's gaze remains focused on an area in the (XR) environment for longer than a predefined duration, an event referred to as a “gaze lock”. In this particular case, the user's gaze is locked onto an advertisement 700, displayed as a poster within the XR environment 1.

Upon the system identifying a gaze lock, the control circuitry captures an image of the area of focus. This image capture process may utilize the embedded cameras or sensors in the user's XR device 110, such as an XR headset or smart glasses. The image may be high-resolution, allowing detailed analysis of the contents within the user's field of view at the time of the gaze lock.

Following the image capture, the system then proceeds to analyze the image to identify the object 10, of focus which, in this case, is a branded beverage in an advertisement poster. Advanced image analysis algorithms, potentially aided by machine learning or AI techniques, may be employed to discern, and classify the object accurately. The image analysis may also involve recognizing any text, logos, or other identifying features present in the image to aid in object identification.

Once an object is identified, the system determines one or more properties 12, of the object 10. These properties could include, but are not limited to, the type of product or service being advertised, the brand associated with the advertisement, the colors or design elements used in the poster, and other relevant properties that can be gleaned from the image.

The system uses the identified properties 12, to update the model of attributes of interest 70. For instance, if the advertisement were for a particular type of product that the user showed interest in, this information would be factored into the model of attributes of interest 70, to potentially influence future product recommendations. This process of updating the model is part of the continuous learning cycle that allows the system to better understand and cater to the user's preferences over time.

Gaze locks, as discussed earlier, occur when a user's gaze remains focused on a specific area in the XR environment 1, for a period exceeding a predetermined threshold. This user behavior is an implicit reaction as it is not a direct or explicit command from the user, but rather an inferred indication of user interest based on their observed behavior.

Implicit reactions such as gaze locks may provide insights into the user's preferences and interests without the need for explicit feedback or input from the user. This is crucial in an environment where user engagement is often non-verbal, and interactions are predominantly visual. Tracking and analyzing gaze behavior can help reveal what a user is interested in, even if they do not actively interact with or select an object.

In some examples, the system may use an aggregate analysis of multiple gaze locks over time to form a more comprehensive and reliable understanding of the user's interests. While a single gaze lock may offer some insight into the user's current focus, it may not necessarily indicate a strong interest or intent to purchase. A user might gaze at an object out of mere curiosity, confusion, or even disinterest. By considering multiple gaze locks, the system can dilute the influence of these outlier interactions and prevent them from skewing the model of attributes of interest 70. This aggregate analysis may involve techniques such as calculating the average, median, or mode of the properties associated with the gaze-locked objects or applying more complex statistical methods to identify dominant trends and patterns. This approach ensures that the model of attributes of interest 70, is reflective of the user's consistent behavior over time, rather than transient interactions, leading to more accurate and personalized recommendations.

In some examples, the system may track and analyze the amount of time a user spends looking at or interacting with an object or area within the XR environment. This duration of engagement may indicate a higher level of interest in the object or area, especially if it significantly exceeds the average engagement time for other objects or areas.

In other examples, the system may monitor and record objects that do not capture the user's attention. For example, if a user frequently passes by Pepsi in a store without pausing to observe the product or its price tag, the system may document this as a lack of interest in Pepsi. This record could act as a reference point in future scenarios to aid in distinguishing the target of the user's gaze and in identifying which attributes are capturing their interest. Suppose the user is gazing at a poster featuring a celebrity endorsing Pepsi. The previously compiled data could suggest that the user's interest is more in the celebrity rather than the product itself. Similarly, if Pepsi is running a promotion, like a prize on opening the bottle cap, and the user's gaze lands on a bottle of Pepsi, the system could interpret that the user's primary interest might be the promotion rather than the product. This insight could be leveraged to encourage the user to purchase a different but preferred soda brand like Dr. Pepper, especially if it is also offering a promotion. The user might not be aware of Dr. Pepper's promotion, and this information could influence their purchasing decision.

In some examples, movement patterns of the user within the XR environment 1, may be monitored and analyzed. The areas or objects that a user frequently visits or interacts with can reveal their preferences and interests. The system may track these movement patterns and update the model of attributes of interest 70, accordingly.

In some examples, physiological responses of the user can be monitored using sensors embedded in the XR device 110. The device may track indicators such as pupil dilation, heart rate, or skin conductance, which can reveal the user's emotional reaction to specific stimuli in the XR environment. This information may be used to infer the user's level of interest or engagement with certain objects or areas.

In some examples, the system may consider the user's proximity and orientation towards certain objects within the XR environment 1. For example, the physical distance between the user and an object 10, or the orientation of the user towards or away from an object, could suggest interest or disinterest. This information may be used to update the model of attributes of interest 70.

In some examples, advanced XR devices equipped with facial recognition capabilities may be configured to analyze a users' facial expressions to infer their emotional reactions to objects or events within the XR environment. These inferred emotional reactions may provide additional insights into the user's preferences and interests and may be used to update the model of attributes of interest 70.

In some examples, the system may capture and analyze the user's body language to infer their state of mind or reactions to certain stimuli. The system may utilize cameras or sensors to detect these subtle physical cues and incorporate the insights into the model of attributes of interest 70. This can help to further personalize the user's XR experience.

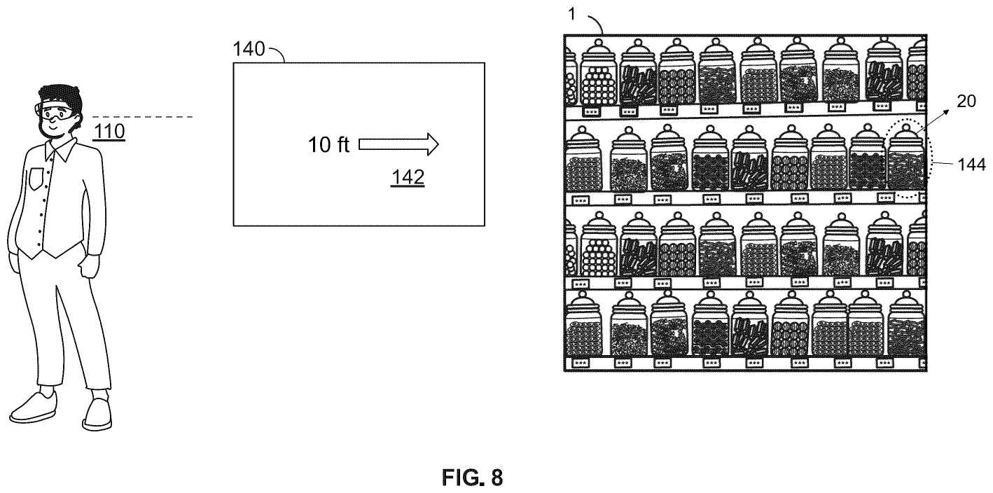

FIG. 8 illustrates an example of how the system might implement the method, wherein the virtual overlay 140, assists users by visually highlighting recommended objects and providing navigational instructions within the XR environment 1.

The user, wearing an XR device 110, such as smart glasses or a headset, is viewing a scene in the XR environment. The system has identified a second object 20, a recommended product that aligns more closely with the user's current attribute of interest. The system then generates a virtual overlay 140, that performs two primary functions; visual emphasis of the second object 20, and navigational assistance 142.

The visual emphasis of the second object 20, is depicted through a distinct visual indicator 144. In one instance, this might be a colored border encircling the product. However, several alternatives can be used to differentiate the recommended product from the surroundings in the XR environment. For example, the system could cause the second object 20, to glow, pulse, or display animated elements such as flashing colors or zoom. Furthermore, the system could enhance the object's visual prominence by altering its contrast or brightness relative to the background, or by superimposing a 3D arrow or icon above it.

The second part of the virtual overlay 140, involves providing navigational instructions 142, to guide the user to the physical location of the recommended product, particularly in a real-world retail context. This could be achieved by displaying a path or arrows in the XR environment 1, that lead to the product. The path could appear as a glowing trail, or a series of floating symbols. Alternatively, the system could generate a 3D map or a mini map in a corner of the user's field of view, showing the user's current location and the location of the second object 20. In a more advanced scenario, the system could even provide turn-by-turn instructions, akin to a GPS navigation system, with textual or auditory prompts indicating when and where to move.

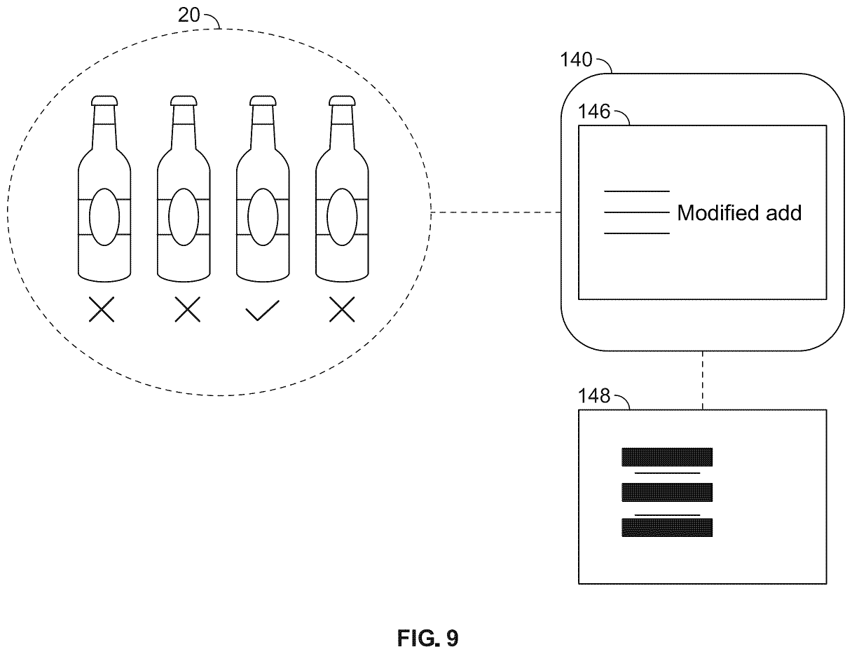

FIG. 9 provides an illustration of a scenario where the virtual overlay 140, comprises a modified advertisement 146, for the second object 20. This modified advertisement is tailored to the user's current attributes of interest, as determined by the system, enhancing its relevance and potential impact.

In this example of an XR environment, the user, possibly wearing an XR device, is presented with a virtual overlay 140, showing a modified advertisement for a food item. The system, having determined that the user's current attribute of interest, is ‘low-fat foods’ for example, has tailored the advertisement to highlight this specific feature. A longer, pre-existing advertisement 148, for this product might include information about its taste, ingredients, cooking instructions, and nutritional benefits, among other things. However, in this modified version 146, the system has selectively shown only the segments that emphasize the low-fat content, thus aligning the advertisement more closely with the user's interest.

The system's ability to modify advertisements is not limited to this specific scenario. For instance, if a user's attribute of interest is ‘environmentally friendly products’, the system could modify an advertisement to highlight the product's eco-friendly packaging or its carbon-neutral manufacturing process.

The modification of advertisements can take various forms. It might involve splicing a video to include only relevant sections or altering the audio to emphasize certain features. The system could also modify the visual aspects of an advertisement, such as changing the color scheme to match the user's preferences or adding text overlays to highlight specific product features. If the user's attribute of interest relates to price sensitivity, the system might add a prominent banner displaying a discounted price or a limited-time offer.

In addition to modifying the content of the advertisement, the system might also adjust its presentation based on the user's preferences. For example, if the system determines that the user prefers short, concise information, it might condense the advertisement to a brief, high-impact message. Alternatively, if the user tends to engage more with interactive content, the system could add interactive elements to the advertisement, such as clickable buttons for more information or a virtual “try-on” feature.

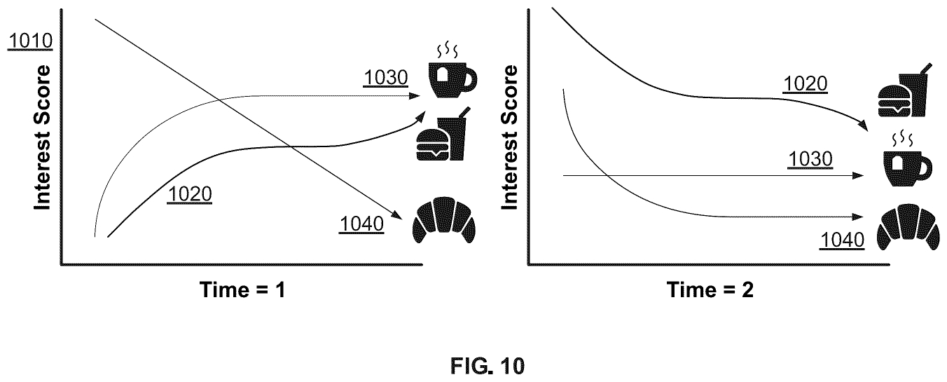

FIG. 10 illustrates and example of a scoring system within the model of attributes of interest. The illustration shows two graphs, labelled in an x-axis as Time=1 and Time=2, which represent different periods of the day, such as morning and afternoon, respectively. These graphs may plot an interest score on the y-axis against time on the x-axis, however the x and y axes may represent any suitable pair of variables. Each line in the graph corresponds to a different food item, such as coffee, croissant, or fast food, which are representative of groupings of various attributes of interest, forming actual tangible items as opposed to individual attributes like ‘high-fat’ or ‘low-salt’. However, individual attributes may still be used.

In these graphs, the interest score 1010 for each food item varies over time, reflecting changes in the user's predicted interest in the item based on the model of attributes of interest. For instance, the line representing fast food 1020, shows a lower interest score in the morning (Time=1), suggesting that this item is less desirable to the user during this time. In contrast, the interest score for fast food 1020, increases in the afternoon (Time=2), which might align with a common lunchtime preference.

However, the overall interest score for fast food might still be lower than that for a healthier food choice 1040, due to the inherent nutritional content of other items. This overall score is reflected in the position of the items in comparison to other lines on the graph.

The graph at Time=2 shows a linear line for coffee 1030, indicating that the desirability of this item remains constant throughout the afternoon and evening. This might suggest that the specific time within this period does not significantly affect the user's interest in fast food.

Another aspect highlighted by these graphs is the system's ability to track attribute selection over time. For example, if the system recognizes that a user has consumed a high-caffeine item earlier in the day, it might decrease the interest score for other high-caffeine items for the rest of that day, reflecting the assumption that the user may not desire more high-caffeine beverages.

While the graphs in FIG. 10 specifically deal with food items, the same principles apply to all objects within the system. For any given object, the interest score can vary based on the time of day, the inherent attributes of the object, the user's past selections, and other factors.

The process of determining interest scores and adjusting them over time as depicted in FIG. 10 is a highly technical operation that relies on objective data analysis. The system's ability to calculate these scores and adjust them dynamically is predicated on complex algorithms, machine learning techniques, and real-time data processing capabilities.

The system may collect and analyze large volumes of data to ascertain the user's preferences. This data could include explicit inputs such as user selections, but also implicit signals such as gaze tracking information and duration of attention to specific objects. The system may process this raw data, often in real-time, to extract meaningful insights about the user's preferences and interests.

The determination of interest scores for different objects may require sophisticated machine learning models. These models may be trained on historical data to recognize patterns and correlations between different attributes and user behaviors. Furthermore, the system may be configured to learn and adapt as new data comes in, enabling it to adjust the interest scores dynamically to reflect changes in user behavior or context.

Moreover, the system must also account for time-dependent variations in user preferences. This involves tracking the user's interactions over time and identifying temporal patterns in their behavior. The system must then incorporate these patterns into its calculations, adjusting interest scores based on the time of day or other temporal factors.

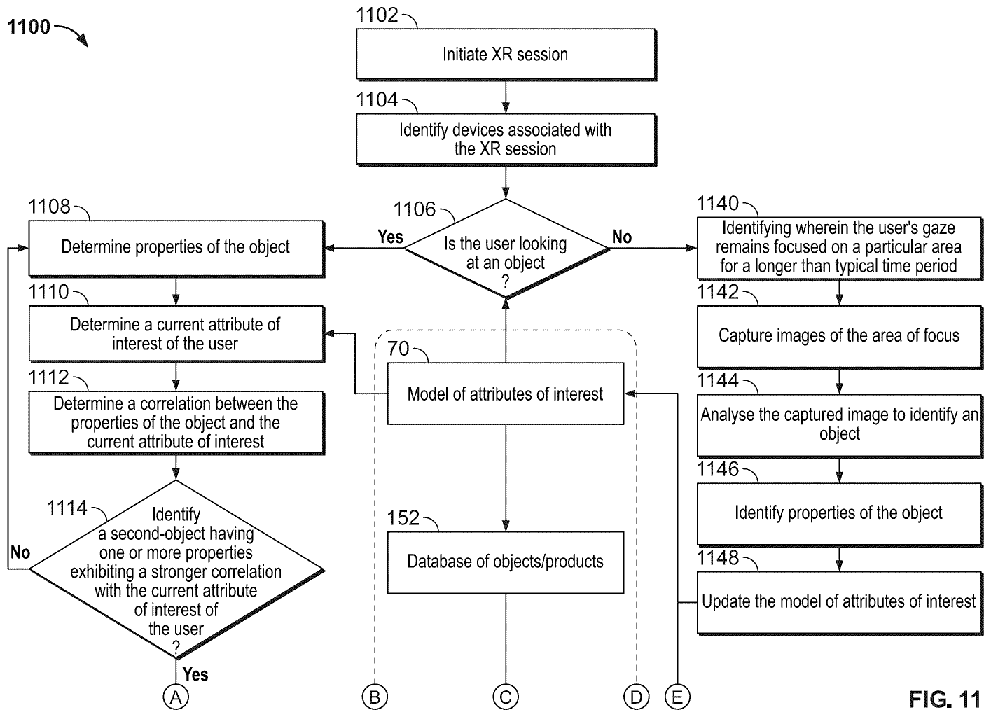

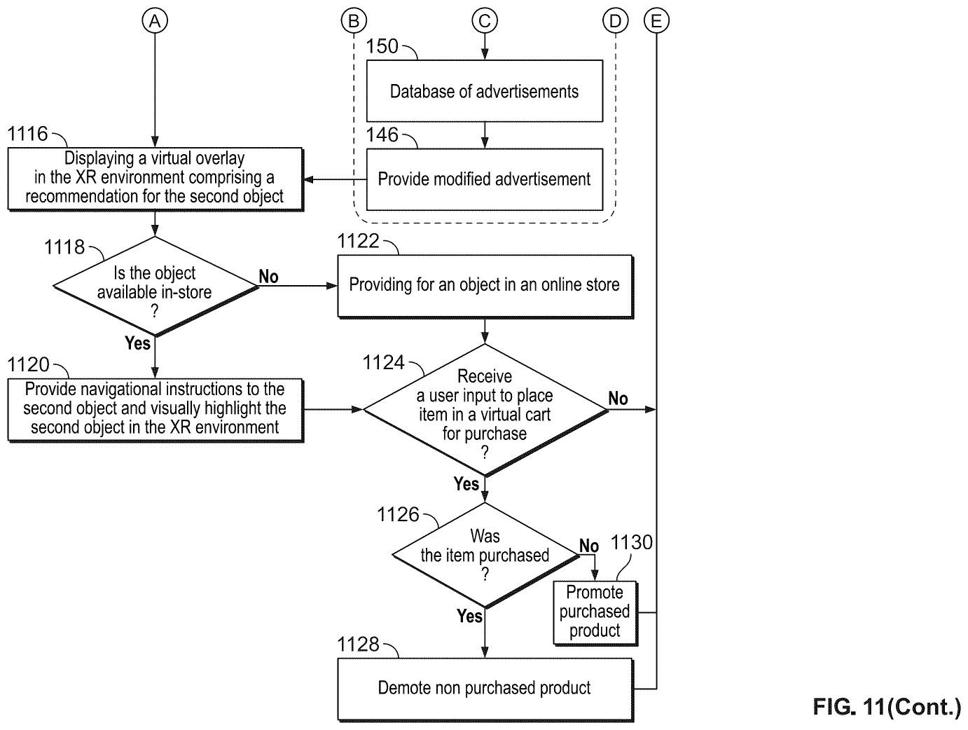

FIG. 11 presents a flowchart representing an illustrative process 1100 displaying a virtual overlay 140, in the XR environment 1, comprising a recommendation for the second object 20, while monitoring a user selection and purchase and updating a model of attributes of interest 70. While the example shown in FIG. 11 references the use of the system depicted in previous figures, it should be appreciated that the illustrative process shown in FIG. 11 may be implemented, in whole or in part, on any appropriately configured system architecture.

At 1102, control circuitry, such as control circuitry of the XR device 110, initiates an XR session. This could occur, for example, when a user dons the XR device 110, or activates the XR system in some other way. For example, the described gaze tracking and product recommendation techniques might be activated in response to user input. For example, by default the XR device might not implement the gaze tracking and/or product recommendation techniques. When the user wants help shopping, for example, he might activate the feature. For example, he might utilize voice input or gesture input to command the XR headset to enable the “shopping assistance” feature. In some instances, the described gaze tracking and product recommendation techniques are always active (e.g., in response to a user having opted-in to this feature always being on). At 1104, control circuitry, such as that of the XR device 110, identifies one or more devices associated with the XR session. For instance, upon initiation of the XR session, the XR device 110, could scan the vicinity for any devices operationally capable of interfacing with the XR device 110, creating an interactive XR environment.

At 1106, the control circuitry checks if the user is looking at an object 10. This could be accomplished using gaze tracking technology integrated into the XR device 110. If the user is looking at an object, the process moves to 1108. If the user is not looking at an object, the process moves to 1140.

At 1108, the control circuitry determines the properties 12, of the object the user is looking at. It then moves to 1110, where it determines the user's current attribute of interest 75, informed by a model of attributes of interest 70.

At 1112, the control circuitry determines a correlation between the properties 12, of the object and the current attribute of interest 75, of the user. If there is a stronger correlation with another object, the control circuitry identifies this second object 20, at 1114. Otherwise, if a stronger correlation with another object is not found, the system reverts back to 1108.

At 1116, the control circuitry displays a recommendation for the second object 20, in a virtual overlay 140, in the XR environment. This recommendation can also include a modified advertisement 146, informed by a database of advertisements 150, that is informed from a database of products 152, that match the object.

At 1118, the control circuitry checks if the object is available in-store. If it is, the process moves to 1120, where it provides navigational instructions to the second object 20, and visually highlights the second object 20, in the XR environment. If not, the process moves to 1122, where it provides for an object in an online store.

At 1124, the control circuitry receives a user input to either place the item in a virtual cart for purchase or, if not, the control circuitry feeds this information into the model of attributes of interest 70, updating it according to the user's actions, and then moves to 1126.

At 1126, the control circuitry checks whether the item was purchased. If it was, the process moves to 1128, where it promotes the purchased product. If it was not, the process moves to 1130, where it demotes the non-purchased product. Both 1128 and 1130 feed back into the model of attributes of interest 70, helping it to learn from user behavior and improve future recommendations.

Initially during this process, the user was not looking at an object at 1106, the process moves to 1140. Here, the control circuitry identifies if the user's gaze remains focused on a particular area for a longer than typical time period. It then moves to 1142, where it captures images of the area of focus, and to 1144, where it analyses the captured images to identify an object.

At 1146, the control circuitry identifies properties 12, of the object and updates the model of attributes of interest 70, at 1148. This updated model feeds back into the process at 1106, where the system determines if the user is looking at an object, and at 1110, where it determines the current attribute of interest 75, of the user. This iterative process allows the system to continually refine its understanding of the user's attributes of interest based on their interactions in the XR environment.

The actions or descriptions of FIG. 11 may be done in any suitable alternative orders or in parallel to further the purposes of this disclosure.

In some instances, the XR system utilizes virtual overlays to provide real-time in-person alerts relating, for example, to objects a user has previously considered (e.g., indicated by the user having gazed at the object in the past without purchasing it). For example, the XR system may compare the object to the recommended product that the user ultimately purchase. In some instances, the user may have considered the object without purchasing it or any alternative. The XR system may conclude that the user chose not to purchase the object due to price. Accordingly, the XR system may notify the user in the future if the object has dropped in price. In some embodiments, the XR system may identify or rank reasons that the user chose not to purchase an object. For example, if the user's gaze was primarily focused on the nutrition label, and the XR system is aware that the system has a general preference for low carb foods, the system might conclude that the user chose not to make the purchase because of the carb count of the object. This might be the case even if other valid reasons exist for why the user might not have purchased the item. For example, maybe the user generally prefers a different flavor or variant of the object in question. Or perhaps the user generally prefers a larger size or quantity of the object in question.

The processes described above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one example may be applied to any other example herein, and flowcharts or examples relating to one example may be combined with any other example in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
identifying, using control circuitry, a first object to which the gaze of a user is directed in an XR environment;
determining, using control circuitry, one or more properties of the first object;
determining, using control circuitry, a current attribute of interest of the user;
determining, using control circuitry, a correlation between the one or more properties of the first object and the current attribute of interest of the user;
in response to the determining the correlation, identifying, using control circuitry, a second object having one or more properties exhibiting a stronger correlation with the current attribute of interest of the user; and
in response to identifying the second object, generating for display, using control circuitry, a virtual overlay in the XR environment comprising information relating to the second object.

2. The method of claim 1, the method comprising:
determining a product category of the first object, wherein identifying the second object comprises:
selecting the second object from a set of objects belonging to the product category of the first object.

3. The method of claim 2, the method comprising:
receiving a data input from a transaction database;
determining, based on the received data, whether the second object is purchased by the user.

4. The method of claim 3, the method comprising:
updating a database containing a model of attributes of interest of the user by:
i. increasing a relevance score of the attributes corresponding to a purchased object; and/or
ii. decreasing a relevance score of the attributes corresponding to a non-purchased object.

5. The method of claim 1, wherein the virtual overlay is interactive, the method comprising:
receiving a user selection of the virtual overlay;
in response to receiving the user selection, adding the second object in a virtual cart for purchase.

6. The method of claim 1, the method comprising:
identifying an area of focus when the user's gaze remains focused on an area in the XR environment for longer than a predetermined period;
capturing an image of the area of focus;
analyzing the image to identify an object in the image;
identifying one or more properties of the object; and
updating, based on the properties of the object, a model of attributes of interest of the user.

7. The method of claim 1, wherein the virtual overlay comprises:
i. visually highlighting the second object in the XR environment; and/or
ii. navigational instructions to the second object in the XR environment.

8. The method of claim 1, wherein the virtual overlay comprises a modified advertisement for the second object.

9. The method of claim 1, the method comprising training a model of attributes of interests for the user using user interactions with the first object, the second object and/or one or more virtual overlays.

10. The method of claim 9, the method comprising:
determining a user reaction relating to the first object, the second object and the virtual overlay;
training the model based on the user reaction; and
updating the model of attributes of interest using the trained data.

11. A system comprising control circuitry configured to:
identify a first object to which the gaze of a user is directed in an XR environment;
determine one or more properties of the first object;
determine a current attribute of interest of the user;
determine a correlation between the one or more properties of the first object and the current attribute of interest of the user;
identify, in response to the determined correlation, a second object having one or more properties exhibiting a stronger correlation with the current attribute of interest of the user; and
generate for display, in response to identifying the second object, a virtual overlay in the XR environment comprising information relating to the second object.

12. The system of claim 11, wherein the control circuitry is configured to:
determine a product category of the first object, wherein identifying the second object comprises:
selecting the second object from a set of objects belonging to the product category of the first object.

13. The system of claim 12, wherein the control circuitry is further configured to:
receive a data input from a transaction database; and
determine, based on the received data, whether the second object is purchased by the user.

14. The system of claim 13, wherein the control circuitry is further configured to:
update a database containing a model of attributes of interest of the user by:
i. increasing a relevance score of the attributes corresponding to a purchased object; and/or
ii. decreasing a relevance score of the attributes corresponding to a non-purchased object.

15. The system of claim 11, wherein the virtual overlay is interactive, the control circuitry is configured to:
receive a user selection of the virtual overlay; and
add the second object in a virtual cart for purchase in response to receiving the user selection.

16. The system of claim 11, wherein the control circuitry is configured to:
identify an area of focus when the user's gaze remains focused on an area in the XR environment for longer than a predetermined period;
capture an image of the area of focus;
analyse the image to identify an object in the image;
identify one or more properties of the object; and
update, based on the properties of the object, a model of attributes of interest of the user.

17. The system of claim 11, wherein the virtual overlay comprises:
i. visually highlighting the second object in the XR environment; and/or
ii. navigational instructions to the second object in the XR environment.

18. The system of claim 11, wherein the virtual overlay comprises a modified advertisement for the second object.

19. The system of claim 11, wherein the control circuitry is configured to train a model of attributes of interests for the user using user interactions with the first object, the second object and/or one or more virtual overlays.

20. The system of claim 19, wherein the control circuitry is further configured to:
determine a user reaction relating to the first object, the second objects and the virtual overlay;
train the model based on the user reaction; and
update the model of attributes of interest using the trained data.

21-50. (canceled)
